(19) United States
(12) Patent Application Publication
(10) Pub. No.: US 2017/0225469 A1
(43) Pub. Date: Aug. 10, 2017

(54) LIQUID EJECTING APPARATUS

(71) Applicant: SEIKO EPSON CORPORATION, Tokyo (JP)

(72) Inventor: Yusuke HIRASAWA, Matsumoto-shi (JP)

(21) Appl. No.: 15/418,145

(22) Filed: Jan. 27, 2017

(30) Foreign Application Priority Data
Feb. 4, 2016 (JP) 2016-019526

(51) Int. Cl. B41J 2/165

(52) U.S. Cl. CPC B41J 2/16508; B41J 2/16532

(57) ABSTRACT

A liquid ejecting apparatus includes a liquid ejecting head which ejects liquid, and a liquid receiving unit which receives the liquid ejected from the liquid ejecting head, in which the liquid receiving unit includes a receiving member which receives the liquid from the liquid ejecting head, a pressure chamber which can communicate with the outside through the receiving member, and a negative pressure generating mechanism which generates a negative pressure in the pressure chamber, and the receiving member is a porous member which seals the pressure chamber by being impregnated with the liquid.

### BACKGROUND

1. Technical Field

The present invention relates to a liquid ejecting apparatus.

2. Related Art

As an example of a liquid ejecting apparatus, there is an ink jet printer which performs borderless printing in which there is no margin at an end portion of a sheet, by ejecting ink from nozzles which are provided in a liquid ejecting head so that there is no margin at the end portion of the sheet.

Such a printer has a configuration in which a platen supporting a medium is provided with a slot in which an absorbing member is arranged, and ink droplets which run off from an end portion of a sheet are received by the absorbing member. Since there is a limit in waste liquid absorbing capacity of the absorbing member, waste liquid received by the absorbing member is introduced to a waste liquid tray which is disposed below the platen. As a method of introducing waste liquid to the waste liquid tray, a method of introducing waste liquid to the waste liquid tray through another absorbing member with a high osmotic force of ink (JP-A-2004-9700), or the like, is known.

In the introducing method described in JP-A-2004-9700, there has been a problem in that removal efficiency is low, since introducing of waste liquid is performed depending on an osmotic force of an absorbing member. In addition, a method of introducing waste liquid through a driving unit such as a suctioning pump is also taken into consideration; however, there has been a problem in that a structure thereof becomes complicated.

Such a problem is not limited to a printer which performs printing by ejecting ink, and is common to a liquid ejecting apparatus, in general, which collects liquid discharged from a liquid ejecting head for maintenance, in addition to liquid ejected toward a medium support unit from a liquid ejecting head.

### SUMMARY

An advantage of some aspects of the invention is to provide a liquid ejecting apparatus which can efficiently collect waste liquid which is generated in the apparatus.

According to an aspect of the invention, there is provided a liquid ejecting apparatus which includes a liquid ejecting head which ejects liquid, and a liquid receiving unit which receives the liquid ejected from the liquid ejecting head, in which the liquid receiving unit includes a receiving member which receives the liquid from the liquid ejecting head, a pressure chamber which can communicate with the outside through the receiving member, and a negative pressure generating mechanism which generates a negative pressure in the pressure chamber, and the receiving member is a porous member which seals the pressure chamber by being impregnated with the liquid.

According to the configuration, the receiving member includes the porous member which is impregnated with liquid. In the porous member which is impregnated with liquid, when a negative pressure is applied to one side, a meniscus is formed on the other side due to a surface tension. The meniscus is a phenomenon in which a liquid surface becomes a recessed shape, and which causes a holding force for holding liquid in a hole in equilibrium with a predetermined negative pressure. When liquid is supplied to the receiving member from the liquid ejecting head, the recessed meniscus is filled with liquid. For this reason, the pressure chamber in the negative pressure state draws in liquid until the meniscus is formed again in the hole of the receiving member. In such an operation of drawing liquid to the negative pressure side from the porous member which is impregnated with liquid, high response and high efficiency can be obtained. Therefore, according to the configuration, it is possible to efficiently remove liquid received by the receiving member without using a driving source, and make a configuration of the apparatus simple.

In the liquid ejecting apparatus, the negative pressure generating mechanism may include a movable wall which configures a part of a wall face of the pressure chamber, and can be displaced in a direction of changing an inner volume of the pressure chamber, and an urging member which urges the movable wall in a direction of increasing the inner volume of the pressure chamber.

According to the configuration, it is possible to generate a negative pressure in the pressure chamber with a simple structure in which the urging member urges the movable wall.

In the liquid ejecting apparatus, the pressure chamber may be provided with a discharging hole for discharging the received liquid.

According to the configuration, since it is possible to discharge liquid (waste ink) which is filed in the pressure chamber, a long life span of the liquid ejecting apparatus can be secured without depending on a capacity of the pressure chamber.

In the liquid ejecting apparatus, the movable wall may include a plate body which faces the discharging hole, and the plate body may close the discharging hole along with a decrease in inner volume of the pressure chamber.

According to the configuration, there is no case in which the plate body automatically closes the discharging hole, after discharging the liquid (waste ink) which is filled in the inside of the pressure chamber, and a load is applied into the pressure chamber. Therefore, according to the configuration, it is possible to omit another mechanism for opening or closing a valve.

In the liquid ejecting apparatus, a cap which can be in close contact with the liquid ejecting head, and a suctioning portion which suctions the liquid from the liquid ejecting head through the cap may be further included, in which the suctioning portion may suction the liquid in the pressure chamber through the discharging hole.

According to the configuration, it is possible to perform maintenance in which an ejection failure such as clogging of nozzles of the liquid ejecting head is resolved, by including the cap which can be in close contact with the liquid ejecting head, and the suctioning portion which is connected to the cap. In addition, the suctioning portion can be used in both of suctioning from the cap and suctioning from the inside of the pressure chamber, by being connected to the discharging hole of the liquid receiving unit. Accordingly, it is possible to make a structure simple, without providing another suctioning portion.

In the liquid ejecting apparatus, an exchangeable waste liquid container which accommodates the liquid suctioned by the suctioning portion may be further included.

According to the configuration, since the liquid receiving unit includes the exchangeable waste liquid container, there is no case in which a life span of the liquid ejecting apparatus depends on a collecting amount of waste liquid in the waste liquid container.

### BRIEF DESCRIPTION OF THE DRAWINGS

The invention will be described with reference to the accompanying drawings, wherein like numbers reference like elements.

FIG. 1 is a perspective view which illustrates the entire structure of a liquid ejecting apparatus according to one embodiment.

FIG. 2 is a top view of the liquid ejecting apparatus in FIG. 1.

FIG. 3 is a schematic view which illustrates a planar configuration in a housing unit.

FIG. 4 is a schematic view which schematically illustrates a cap, a liquid receiving unit, a suctioning portion, and a waste liquid container.

FIG. 5 is a sectional schematic view of a receiving portion in which a meniscus is formed.

FIG. 6 is a sectional schematic view which illustrates an action of the receiving member which receives liquid.

FIG. 7 is a schematic view which schematically illustrates the cap, the liquid receiving unit, the suctioning portion, and the waste liquid container, and illustrates a state in which the liquid receiving unit receives liquid from a nozzle.

FIG. 8 is a schematic view which schematically illustrates the cap, the liquid receiving unit, the suctioning portion, and the waste liquid container, and illustrates a state of suctioning liquid from the liquid receiving unit.

FIG. 9 is a schematic view which schematically illustrates the cap, the liquid receiving unit, the suctioning portion, and the waste liquid container, and illustrates a state of suctioning liquid from the cap.

FIG. 10 is a schematic view which schematically illustrates a liquid receiving unit according to Modification example 1.

FIG. 11 is a schematic view which schematically illustrates a liquid receiving unit according to Modification example 2.

FIG. 12 is a schematic view which schematically illustrates a liquid receiving unit according to Modification example 3.

FIG. 13 is a schematic view which schematically illustrates a liquid receiving unit according to Modification example 4.

### DESCRIPTION OF EXEMPLARY EMBODIMENTS

Hereinafter, an embodiment of a liquid ejecting apparatus according to the invention will be described with reference to drawings. In each figure which is used in the following descriptions, a scale of each member is appropriately changed in order to set each member to have a recognizable dimension.

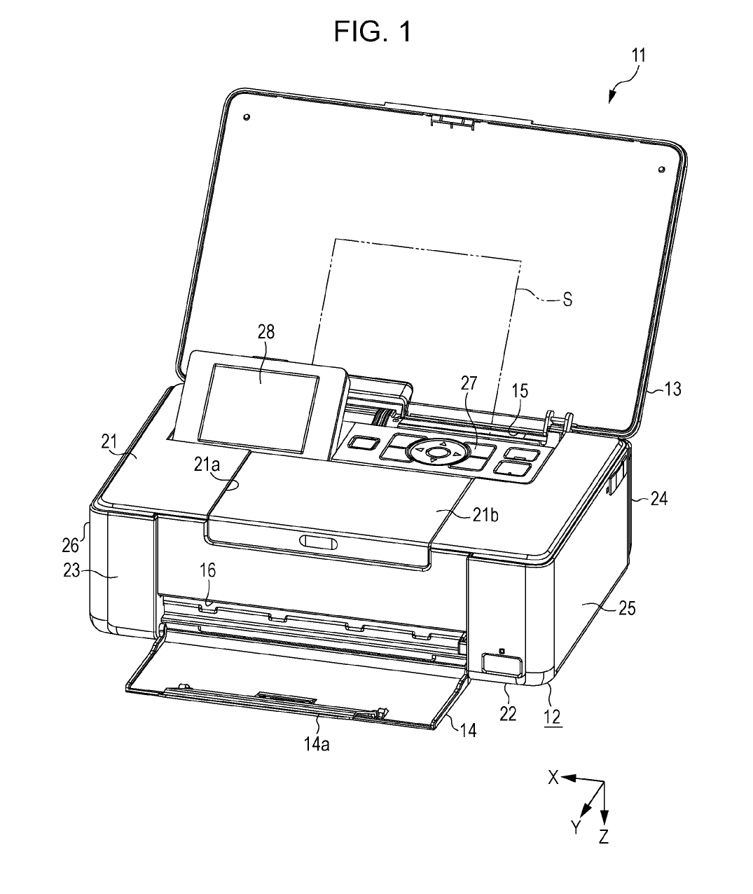

FIG. 1 is a perspective view which illustrates the entire structure of a liquid ejecting apparatus 11 according to a first embodiment. The liquid ejecting apparatus 11 is an ink jet printer which performs recording (printing) by ejecting ink as an example of liquid onto a medium such as a sheet, for example.

The liquid ejecting apparatus 11 is provided with a rectangular box-shaped housing unit 12, an upper lid 13 which is rotatably attached to the housing unit 12, and a front lid 14 which is rotatably attached to the housing unit 12, similarly. The upper lid 13 and the front lid 14 are disposed at a closing position which is overlapped with the housing unit 12, and an open position illustrated in FIG. 1, by being rotated up to a predetermined angle, respectively.

When the upper lid 13 is disposed at the open position, an insertion port 15 for inserting a medium S into the housing unit 12 is exposed. The upper lid 13 which is disposed at the open position functions as a support table (sheet feeding tray) which supports the medium S inserted into the insertion port 15.

When the front lid 14 is disposed at the open position, a discharging port 16 for discharging the medium S from the inside of the housing unit 12 is exposed. The front lid 14 which is disposed at the open position functions as an receiving unit (sheet discharging tray) which receives the medium S discharged from the discharging port 16. An extending portion 14a for extending a length for supporting the medium S is rotatably attached to the front lid 14.

In the housing unit 12, an outer wall to which the insertion port 15 is open is referred to as an upper wall 21, an outer wall on a side opposite to the upper wall 21 is referred to as a bottom wall 22, an outer wall to which the discharging port 16 is open is referred to as a front wall 23, and an outer wall on a side opposite to the front wall 23 is referred to as a rear wall 24. In addition, in the housing unit 12, a pair of outer walls which intersects the upper wall 21, the bottom wall 22, the front wall 23, and the rear wall 24 is referred to as outer walls 25 and 26. In the housing unit 12, there is a case in which the upper wall 21 side is referred to as a top face side, and the bottom wall 22 side is referred to as a bottom face side.

An operation unit 27 for operating the liquid ejecting apparatus 11, and a display unit 28 for displaying an operation result of the operation unit 27, an operation situation of the liquid ejecting apparatus 11, or the like, are disposed on the front face side (top face side) of the upper wall 21.

In addition, an opening portion 21a is provided on the upper wall 21, and an opening-closing lid 21b is attached to the opening portion 21a. The opening-closing lid 21b is disposed at a closing position of covering the opening portion 21a, and an open position of exposing the opening portion 21a, by being rotated up to a predetermined angle.

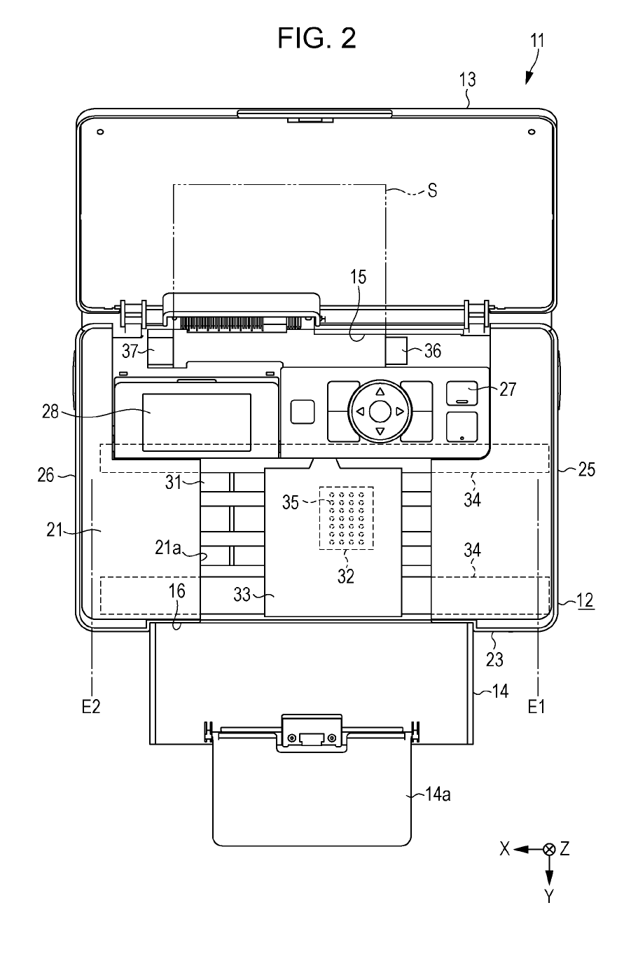

FIG. 2 is a top view of the liquid ejecting apparatus 11.

As illustrated in FIG. 2, a medium support unit 31 for supporting the medium S, a liquid ejecting head 32 which ejects liquid onto the medium S supported by the medium support unit 31, and a carriage 33 which reciprocates by holding the liquid ejecting head 32 are accommodated in the housing unit 12. In addition, a guide rail 34 for guiding a movement of the carriage 33 is installed in the housing unit 12. In FIG. 2, the opening-closing lid 21b is not illustrated, in order to clearly show a configuration in the housing unit 12.

The liquid ejecting head 32 includes a plurality of nozzles 35 which eject liquid as liquid droplets. The liquid ejecting head 32 alternately performs an outward movement of going toward a second end E2 side (left end side in FIG. 2) in a longitudinal direction from a home position, and a return movement of going toward the home position from the second end E2 side, by setting a first end E1 side (right end side in FIG. 2) in the longitudinal direction in the housing unit 12 to the home position.

According to the embodiment, a direction in which the liquid ejecting head 32 ejects liquid is referred to as an ejecting direction Z, a direction in which the medium S is transported from the insertion port 15 toward the discharging port 16 on the medium support unit 31 is referred to as a transport direction Y, and a reciprocating direction of the liquid ejecting head 32 is referred to as a scanning direction X. The reciprocating direction of the liquid ejecting head 32 (direction which goes along scanning direction X) is also referred to as a width direction of the medium S. According to the embodiment, the ejecting direction Z is a vertically lower direction (gravity direction), and the ejecting direction Z, the transport direction Y, and the scanning direction X are directions which intersect each other (orthogonal, preferably).

The insertion port 15, the medium support unit 31, and the discharging port 16 align in order from the upstream side toward the downstream side in the transport direction Y, and form a transport path of the medium S. The medium support unit 31 is disposed in the vicinity of a center in the housing unit 12 in the scanning direction X. The home position is set to a position near to the first end E1, rather than the medium support unit 31. In addition, the insertion port 15 is provided with guide portions 36 and 37 for determining an end portion position of the medium S in the scanning direction X, in the transport path.

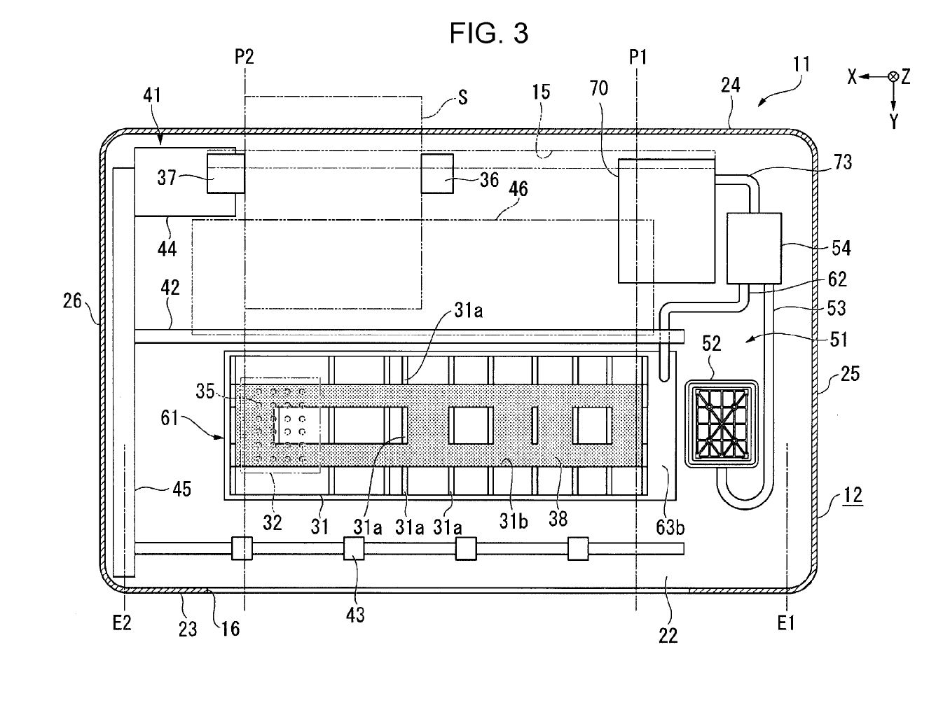

FIG. 3 is a schematic view which illustrates a planar configuration in the housing unit 12.

As illustrated in FIG. 3, a first guide portion 36 determines an end portion position of the medium S which is disposed on the transport path on a first end P1 side (right end side in FIG. 2) in the width direction. In addition, a second guide portion 37 determines an end portion position of the medium S which is disposed on the transport path on a second end P2 side (left end side in FIG. 2) in the width direction.

The first guide portion 36 can move along the scanning direction X in a sliding manner, and brings the medium S to the second end P2 side on the transport path, by moving in a direction (scanning direction X) of getting closer to the second end P2 side while being in contact with the first end P1 in the width direction of the medium S which is inserted into the insertion port 15. In addition, the medium S is transported in a state of being positioned on the second end P2 side in the width direction on the transport path.

A transport unit 41 which transports the inserted medium S from the insertion port 15 toward the discharging port 16, a maintenance mechanism 51 for performing maintenance of the liquid ejecting head 32, and a waste liquid container 70 which accommodates liquid discharged as waste liquid, from the liquid ejecting head 32 are accommodated in the housing unit 12.

The transport unit 41 is provided with a transport roller 42 which transports the medium S from the insertion port 15 toward the medium support unit 31, and a discharging roller 43 which transports the medium S from the medium support unit 31 toward the discharging port 16. In addition, the transport unit 41 is provided with a transport motor 44 as a driving source, a power transmitting mechanism 45 which is formed of a gear train, or the like, for transmitting a driving force of the transport motor 44 to the transport roller 42 and the discharging roller 43, and a transport path forming member 46 which forms a transport path of the medium S between the insertion port 15 and the medium support unit 31. The transport roller 42 is formed of a metal bar of which surface roughness is adjusted, using surface finishing, for example.

The maintenance mechanism 51 is provided with a cap 52 which is disposed at a position corresponding to the home position, and a suctioning portion 54 which is connected to the cap 52 through a first suctioning tube 53. The cap 52 according to the embodiment is a cap which is formed in a bottomed box shape.

The cap 52 can move along the ejecting direction Z, and moves between a capping position of being in close contact with the liquid ejecting head 32 located at the home position and a retreat position which is close to the bottom wall 22 rather than the capping position.

When the cap 52 moves to the capping position of being in contact with the liquid ejecting head 32, the cap 52 forms a closed space to which a nozzle 35 opens. Forming the closed space to which the nozzle 35 opens due to the cap 52 in this manner is referred to as “capping”. When the cap 52 moves from a capping position to a retreat position, capping is released. When the cap 52 performs capping of the nozzle 35 by being in close contact with the liquid ejecting head, drying of the nozzle 35 is suppressed.

The suctioning portion 54 is, for example, an suctioning pump which is formed of a tube pump, or the like, which generates a suctioning force when a pressing member moves while crushing a tube which can be elastically deformed. When the suctioning portion 54 is driven, the closed space is depressurized, and enters a negative pressure state. In this manner, suctioning cleaning in which liquid is discharged from the liquid ejecting head 32 through the nozzle 35 is performed. The suctioning cleaning is performed as a maintenance operation for resolving such an ejection failure, in a case in which the ejection failure of liquid occurs, or the like, due to clogging, or the like, of the nozzle 35, for example. For this reason, liquid discharged from the nozzle 35 using suctioning cleaning is accommodated in the waste liquid container 70 through a discharging tube 73, as waste liquid containing air bubbles mixed in the liquid ejecting head 32, a solute component of thickened liquid, or the like.

Capping is released when the cap 52 is relatively moved in a direction separated from the liquid ejecting head 32, after performing the suctioning cleaning. In addition, idle suctioning in which liquid remained in the cap 52 is collected in the waste liquid container 70 is performed thereafter, by driving the suctioning portion 54.

As a maintenance operation for resolving the ejection failure, flushing in which liquid droplets are ejected toward the cap 52 located at the retreat position using the liquid ejecting head 32 is performed. In addition, idle suctioning in which liquid received by the cap 52 is collected in the waste liquid container 70 is performed after performing the flushing, by driving the suctioning portion 54.

The suctioning portion 54 is connected to a liquid receiving unit 61 thorough a second suctioning tube 62, as will be described later. In addition, the suctioning portion 54 is connected to the waste liquid container 70 through a discharging tube 73. The suctioning portion 54 suctions liquid from the cap 52 and the liquid receiving unit 61, and introduces the liquid to the waste liquid container 70.

Support protrusions 31a which extend in a rib shape extending in the transport direction are provided in the medium support unit 31 so as to align in the scanning direction X and the transport direction Y. The support protrusion 31a supports the medium S.

A groove hole 31b which extends in the scanning direction X of the liquid ejecting head 32 is provided in the medium support unit 31. A receiving member 38 of the liquid receiving unit 61 is exposed in the groove hole 31b. The receiving member 38 receives liquid droplets which are ejected from the liquid ejecting head 32 toward an end portion of the medium S, and run off without being received in the medium S, in a case in which borderless printing in which printing is performed up to an edge of the medium S without a margin is performed.

That is, the liquid ejecting head 32 ejects liquid onto the medium S which is transported in the transport direction Y in a state of which an end portion position is set to the second end P2 side between the first end P1 and the second end P2 in the width direction of the transport path, in a case in which a direction which intersects the transport direction Y is set to the width direction. The medium support unit 31 includes the support protrusion 31a which supports the medium S, and the receiving member 38 which receives liquid ejected from the liquid ejecting head 32 toward the end portion of the medium S, and is not received in the medium S as waste liquid, and is disposed on the transport path. In contrast to this, the cap 52 is disposed on the outer side of the first end P1 on the transport path, and receives liquid discharged from the liquid ejecting head 32 as waste liquid. In addition, the liquid receiving unit 61 accommodates waste liquid which is received by the cap 52 and the receiving member 38.

### Liquid Receiving Unit

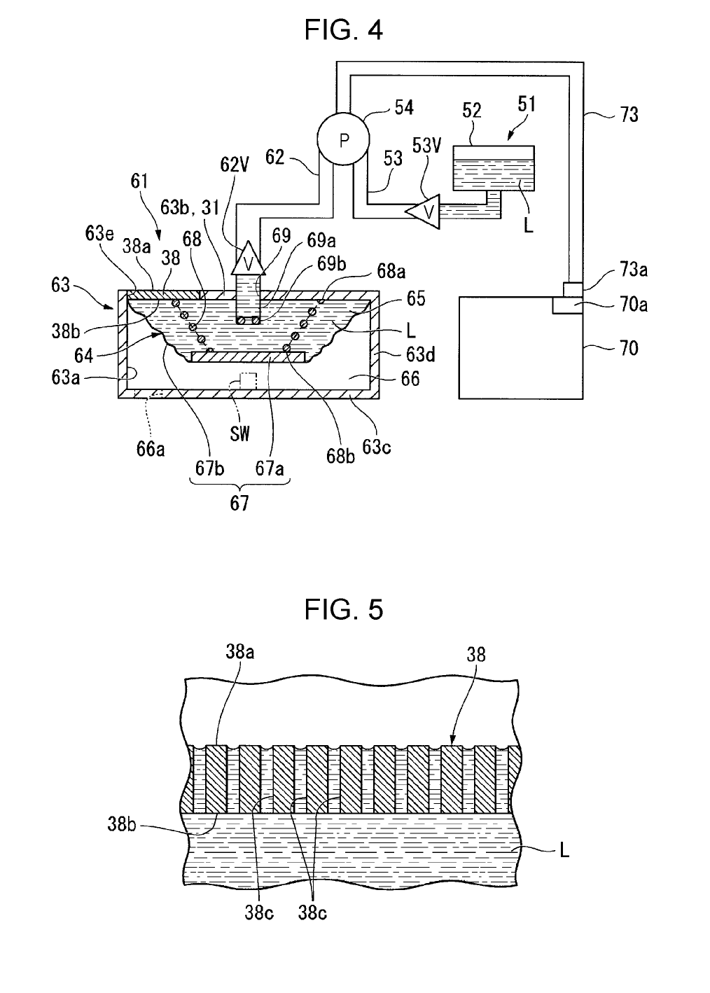

FIG. 4 is a schematic view which schematically illustrates the cap 52, the liquid receiving unit 61, the suctioning portion 54, and the waste liquid container 70. FIG. 4 is a sectional schematic view of the liquid receiving unit 61 in the vicinity of the second suctioning tube 62 in FIG. 3.

As illustrated in FIG. 4, the cap 52 is connected to the suctioning portion 54 thorough the first suctioning tube 53. The first suctioning tube 53 includes a first differential pressure valve 53V in the middle of a path. The first differential pressure valve 53V causes liquid to flow from the cap 52 toward the suctioning portion 54, in a case in which a pressure on the cap 52 side with respect to a pressure on the suctioning portion 54 side is a predetermined differential pressure value P53 or more, in the inside of the first suctioning tube 53.

Similarly, the liquid receiving unit 61 is connected to the suctioning portion 54 thorough the second suctioning tube 62. The second suctioning tube 62 includes a second differential pressure valve 62V in the middle of a path. The second differential pressure valve 62V causes liquid to flow from the liquid receiving unit 61 toward the suctioning portion 54, in a case in which a pressure on the liquid receiving unit 61 side with respect to a pressure on the suctioning portion 54 side is a predetermined differential pressure value P62 or more, in the inside of the second suctioning tube 62.

The differential pressure value P53 in which the first differential pressure valve 53V is operated is larger than the differential pressure value P62 in which the second differential pressure valve 62V is operated (that is, differential pressure value P53>differential pressure value P62, and both of differential pressure values P53 and P62 are positive values).

The suctioning portion 54 is connected to the waste liquid container 70 thorough the discharging tube 73. Liquid (waste ink) is suctioned from the cap 52 and the liquid receiving unit 61 using the suctioning portion 54, and is collected in the waste liquid container 70. The discharging tube 73 includes a joint member 73a at a terminal end on the waste liquid container 70 side. The waste liquid container 70 includes a receiving member 70a to which the joint member 73a is connected. In this manner, the discharging tube 73 is detachable from the waste liquid container 70, and it is possible to exchange the waste liquid container 70 even in a case in which the waste liquid container 70 is filled with waste liquid. That is, it is possible to exchange the waste liquid container 70, and there is no case in which a life span of the liquid ejecting apparatus 11 depends on a capacity of the waste liquid container 70.

A configuration of the liquid receiving unit 61 will be described base on FIG. 4. The liquid receiving unit 61 receives liquid (waste ink) L which is ejected from the liquid ejecting head 32. The liquid receiving unit 61 includes a case member 63 with an opening portion 63e which faces the upper side (direction facing nozzle 35 of liquid ejecting head 32), a negative pressure generating mechanism 64 which is located inside the case member 63, and the receiving member 38 which is fixed to the case member 63.

According to the embodiment, a direction in which the nozzle 35 ejects the liquid L is set to a lower direction (gravity direction) for convenience; however, it may be a direction other than that.

The case member 63 includes an upper wall (first wall) 63b, a lower wall (second wall) 63c, and a side wall (third wall) 63d which connects the upper wall 63b and the lower wall 63c. The case member 63 configures an accommodating space 63a which is surrounded with the upper wall 63b, the lower wall 63c, and the side wall 63d. An opening portion 63e to which the receiving member 38 is attached, and a discharging hole 69 for discharging received liquid are provided on the upper wall 63b.

In addition, according to the embodiment, the upper wall 63b configures a part of the medium support unit 31. However, the upper wall 63b may be a member different from the medium support unit 31.

A pressure chamber 65, and a spare room 66 which is vertically divided by a movable wall 67 are provided in the accommodating space 63a of the case member 63. That is, the liquid receiving unit 61 includes the pressure chamber 65 and the spare room 66. A ratio of a volume in the inside of the pressure chamber 65 and the spare room 66 is changed due to a movement of the movable wall 67.

As denoted by a virtual line (two-dot dashed line) in FIG. 4, a contact switch (detection switch) SW may be provided on the lower wall 63c of the case member 63. The contact switch SW detects the fact that the movable wall 67 moves downward, and reaches a predetermined position. In this manner, the contact switch SW can indirectly detect that a liquid amount of liquid L in the pressure chamber 65 exceeds a threshold value.

According to the embodiment, a case in which the contact switch SW is adopted as the detection switch is exemplified; however, a configuration other than that may be adopted. For example, a displacement of the movable wall 67 may be detected by an optical sensor, instead of the contact switch SW. In this case, it is possible to determine an execution of suctioning for discharging liquid from the inside of the pressure chamber 65 and a stop thereof based on a detection result of the optical sensor.

A detection result of the contact switch SW and a sensor equivalent thereto (for example, the above described optical sensor) may be used in detecting of an operation error of the liquid receiving unit 61. For example, in a case in which a detection result is contradictory to a performed control, for example, a detection result of the contact switch SW is not changed even when suctioning is performed in the pressure chamber 65, or the like, it is possible to determine that there are some problems in the liquid receiving unit 61.

The discharging hole 69 is open to the inside of the pressure chamber 65. The discharging hole 69 is connected to the suctioning portion 54 through the second suctioning tube 62. In addition, a cylindrical portion 69a which extends inside the pressure chamber 65 is fixed to the discharging hole 69. A sealing member 69b which is formed of an elastic member such as rubber is fixed to a tip end of the cylindrical portion 69a so as to cover a tip end face of the cylindrical portion 69a.

The pressure chamber 65 is located on the upper portion in the accommodating space 63a. A wall face which configures the pressure chamber 65 is the movable wall 67, and the upper wall 63b of the case member 63. The pressure chamber 65 can communicate with the outside thorough the receiving member 38. As will be described later, since the receiving member 38 seals the opening portion 63e by being impregnated with the liquid L, the inside of the pressure chamber 65 is hermetically sealed, and a pressure in the pressure chamber 65 is changed due to a movement of the movable wall 67.

The spare room 66 is located on the lower portion in the accommodating space 63a. Wall faces which configure the spare room 66 are the movable wall 67, and the lower wall 63c and the side wall 63d of the case member 63. A thorough hole 66a which causes the inside and outside of the spare room 66 to communicate is provided on the wall face (lower wall 63c in figure) which configures the spare room 66. Due to this, a pressure in the spare room 66 is the same as an atmospheric pressure.

The negative pressure generating mechanism 64 is located inside the case member 63. The negative pressure generating mechanism 64 includes the movable wall 67, and a coil spring (urging member) 68. The movable wall 67 configures a part of wall faces of the pressure chamber 65, and can be displaced in a direction of changing an inner volume of the pressure chamber 65. The coil spring 68 increases the inner volume of the pressure chamber 65 by pressing (urging) the movable wall 67 in a direction of being kept away from the upper wall 63b.

The movable wall 67 includes a pressure receiving plate (plate body) 67a and a film member 67b. The movable wall 67 can be displaced in a direction of changing an inner volume.

The film member 67b is formed of a material with flexibility. The film member 67b is fixed to a peripheral edge of the upper wall 63b by being bonded so as to cover the entire lower face of the upper wall 63b of the case member 63. In addition, a surface area of the film member 67b is set to be larger than an area of the lower face of the upper wall 63b, and is fixed in a loosened state.

The pressure receiving plate 67a is formed of a metal material, a resin material, or the like, and has a sufficient rigidity. The pressure receiving plate 67a is fixed to approximately a center of the film member 67b in a boding manner so as to be approximately parallel to the upper wall 63b of the case member 63. The pressure receiving plate 67a faces the discharging hole 69. The pressure receiving plate 67a reduces the inner volume of the pressure chamber 65, and is in contact with the sealing member 69b which is fixed to a tip end of the cylindrical portion 69a which is fixed to the discharging hole 69. In this manner, the pressure receiving plate 67a closes the discharging hole 69.

When the pressure receiving plate 67a moves upward, sagging of the film member 67b becomes remarkable. In addition, when the pressure receiving plate 67a moves downward, sagging of the film member 67b is reduced, and a tension is generated shortly.

In the coil spring 68, an expanding-contracting direction is set to a vertical direction. The coil spring 68 according to the embodiment is formed in a conical shape in which a diameter becomes small from the upper side toward the lower side. An upper end portion 68a of the coil spring 68 is in contact with the upper wall 63b. A lower end portion 68b of the coil spring 68 is in contact with the pressure receiving plate 67a of the movable wall 67. The coil spring 68 is compressed between the upper wall 63b and the pressure receiving plate 67a. Accordingly, the coil spring 68 urges the movable wall 67 in a direction of increasing the inner volume of the pressure chamber 65. In this manner, the coil spring 68 generates a negative pressure in the inside of the pressure chamber 65.

The coil spring 68 which urges the movable wall 67 may have another configuration (for example, plate spring) when it is an urging unit which causes stress in at least one direction. In addition, a diaphragm may be adopted as one form of the negative pressure generating mechanism in which an urging member and a movable wall are integrated. As a configuration of the negative pressure generating mechanism 64 other than that, it is possible to adopt a pressure reducing pump which is connected to the pressure chamber 65.

In the embodiment, the pressure chamber 65 and the spare room 66 are disposed so as to align in the vertical direction (gravity direction), and may be disposed in a way other than that. The pressure chamber 65 and the spare room 66 may be disposed so as to align in the horizontal direction (direction intersecting gravity direction). In addition, it is possible to appropriately change a layout of the negative pressure generating mechanism 64, the discharging hole 69, the opening portion 63e, the receiving member 38, or the like, according to a disposition of the pressure chamber 65 and the spare room 66.

FIG. 5 is a sectional schematic view of the receiving member 38 illustrated in FIG. 4.

The receiving member 38 is a sheet-shaped porous member which includes a top face (first face) 38a and a lower face (second face) 38b. The receiving member 38 is provided with a plurality of holes 38c which open to the top face 38a and the lower face 38b, respectively, and causes the upper and lower faces of the receiving member 38 to communicate.

In the embodiment, the receiving member 38 will be described as a sheet member in which countless holes 38c are formed. However, a configuration of the receiving member 38 is not limited to this. For example, the receiving member 38 may be cloth in which countless holes are formed along texture, or metal, or non-woven fabric in which holes with an indeterminate form are countlessly formed. In addition, the receiving member 38 may be a sponge-shaped resin member.

The receiving member 38 receives liquid (waste ink) L, and the received liquid L is drawn into the pressure chamber 65. The receiving member 38 is impregnated with the liquid L which is ejected from the liquid ejecting head. When the receiving member 38 as a porous member is impregnated with the liquid L, it enters a state in which the inside of the hole 38c of the receiving member 38 is filled with liquid. In the liquid L in the hole 38c, when a negative pressure is applied to one side, a meniscus is formed in the liquid L in the hole 38c on the other side due to a surface tension. The meniscus is a phenomenon in which a liquid surface becomes a recessed shape, and which causes a holding force for holding liquid in the hole 38c in equilibrium with a predetermined negative pressure. The receiving member 38 seals the opening portion 63e by being impregnated with the liquid L, since the receiving member 38 covers the opening portion 63e by being attached to the opening portion 63e of the pressure chamber 65.

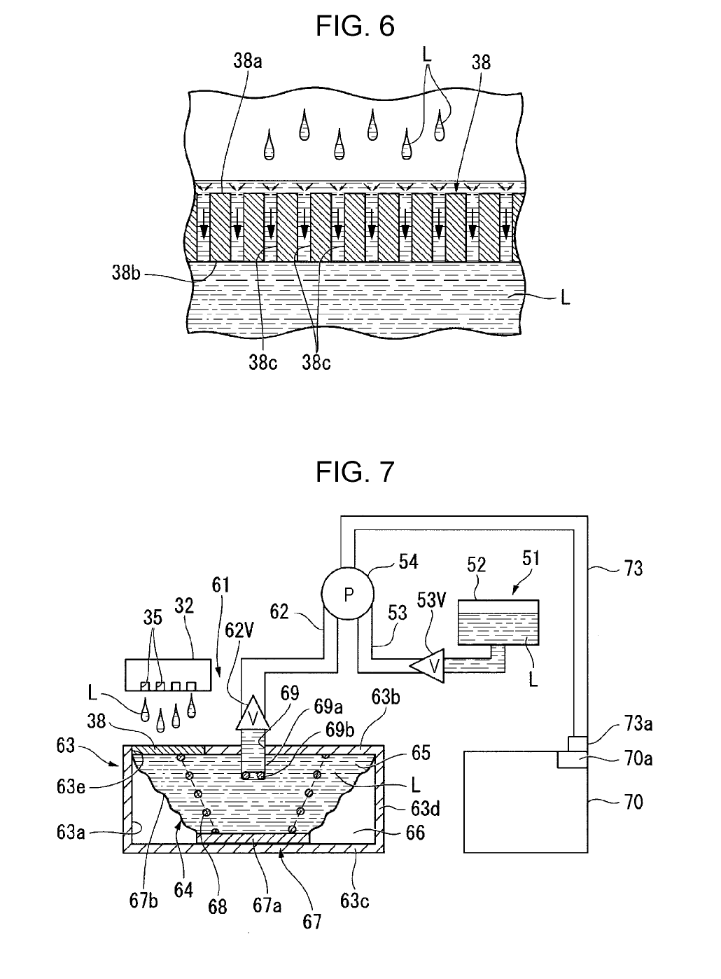

FIG. 6 is a sectional schematic view which illustrates operations of the receiving member 38 when receiving the liquid L.

When the liquid L is supplied from the liquid ejecting head 32 to the receiving member 38, a recessed meniscus is filled with the liquid L. For this reason, the pressure chamber 65 in a negative pressure state draws in the liquid L until a meniscus is formed again in the hole 38c of the receiving member 38. It is possible to obtain a high response and high efficiency in such an operation of drawing the liquid L to the negative pressure side from the receiving member 38 which is impregnated with the liquid L.

### Operation

Similarly to FIG. 4, FIGS. 7 to 9 are schematic views which schematically illustrate the cap 52, the liquid receiving unit 61, the suctioning portion 54, and the waste liquid container 70, and illustrate a collecting procedure of liquid (waste liquid), respectively.

Here, an operation of the liquid ejecting apparatus 11 will be described based on FIGS. 4 to 8.

In the liquid ejecting apparatus 11, liquid droplets which run off from the end portion of the medium S when performing borderless printing are received in the receiving member 38. As illustrated in FIG. 6, when the receiving member 38 receives the liquid L on the top face 38a, the pressure chamber 65 draws in the liquid L through the hole 38c until a meniscus due to the liquid L is formed in the hole 38c of the receiving member 38. In this manner, the operation proceeds to the state in FIG. 7 from the state in FIG. 4. That is, a liquid amount of the liquid L in the pressure chamber 65 increases, and the coil spring 68 extends.

In a case in which an amount of the liquid L in the pressure chamber 65 is close to a limit of a liquid accommodating capacity of the pressure chamber 65, the liquid L is discharged from the pressure chamber 65 through the suctioning portion 54, and is introduced to the waste liquid container 70. An amount of the liquid L in the pressure chamber 65 can be detected by the contact switch SW (refer to FIG. 4) which is provided on the lower wall 63c of the case member 63, for example. Here, descriptions will be made by assuming that the cap 52 of the maintenance mechanism 51 is also filled with the liquid (waste ink) L of a constant amount, not only the pressure chamber 65 of the liquid receiving unit 61. The liquid L filled in the cap 52 is ink ejected (flushed) from the liquid ejecting head 32 as a maintenance operation for resolving an ejection failure.

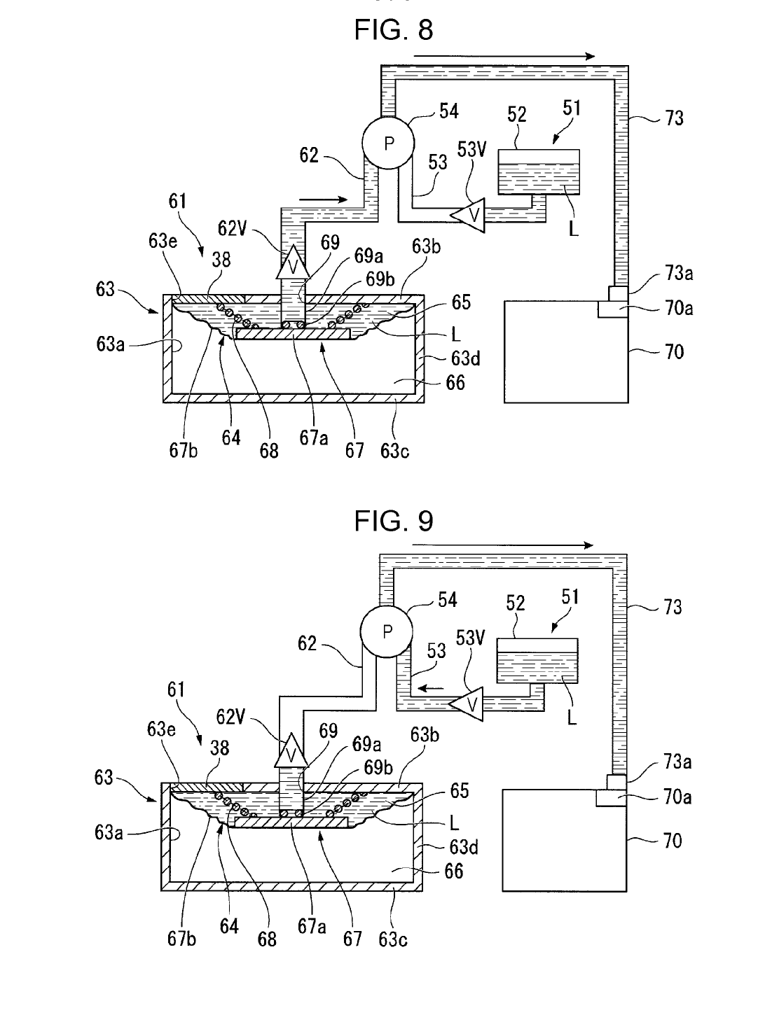

As illustrated in FIG. 8, a pressure on the downstream side of the differential pressure valve when the suctioning portion 54 is driven. When the suctioning portion 54 is driven, a pressure difference occurs before and behind the first differential pressure valve 53V in the first suctioning tube 53, and before and behind the second differential pressure valve 62V in the second suctioning tube 62. Since a differential pressure value P62 with which the second differential pressure valve 62V is operated is smaller than a differential pressure value P53 with which the first differential pressure valve 53V is operated, the second differential pressure valve 62V is operated in advance. In this manner, the suctioning portion 54 suctions the liquid L from the pressure chamber 65 of the liquid receiving unit 61, and introduces the liquid to the waste liquid container 70. When the liquid L is suctioned, the pressure receiving plate 67a moves in a direction of compressing the coil spring 68, and a volume of the pressure chamber 65 decreases. When suctioning of the liquid L proceeds along with this, the pressure receiving plate 67a closes the discharging hole 69 by being in contact with the sealing member 69b, as illustrated in FIG. 8. In this manner, suctioning of the liquid L in the pressure chamber 65 using the suctioning portion 54 is completed.

As illustrated in FIG. 9, when the discharging hole 69 is closed, a pressure difference becomes large before and behind the first differential pressure valve 53V in the first suctioning tube 53, and the first differential pressure valve 53V is operated. In this manner, the suctioning portion 54 introduces the liquid L into the waste liquid container 70 by suctioning the liquid from the cap 52. In this manner, it is possible to remove the liquid L in the cap 52. In addition, it is possible to prevent the liquid L from being suctioned from the cap 52 side when suctioning the liquid from the pressure chamber 65, when the second differential pressure valve 62V is opened in advance of the first differential pressure valve 53V.

Here, a case in which the filled liquid L is removed by the suctioning portion 54 using flushing is described; however, in a case in which the liquid is suctioned from the suctioning portion 54 in a state in which the cap 52 covers the nozzle 35, suctioning cleaning in which liquid is discharged from the liquid ejecting head 32 through the nozzle 35 is performed.

According to the embodiment, the pressure chamber 65 in the negative pressure state is sealed with the receiving member 38 including the porous member which is impregnated with liquid, and the liquid (waste ink) L is received by the receiving member 38. When the receiving member 38 receives the liquid L, it is possible to collect liquid with high efficiency, since the pressure chamber 65 draws in the liquid L until a meniscus due to the liquid L is formed in the receiving member 38. Therefore, according to the embodiment, it is possible to collect the liquid L with high efficiency from the receiving member 38 with a simple structure in which a driving source is not used.

According to the embodiment, it is possible to generate a negative pressure in the inside of the pressure chamber 65 using the coil spring (urging member) 68, and draw the liquid L dropped into the receiving member 38 to the inside of the pressure chamber 65.

According to the embodiment, the discharging hole 69 for discharging the liquid L received in the pressure chamber 65 is provided. Due to this, it is possible to discharge the liquid L filled in the pressure chamber 65. In a case in which the discharging hole 69 is not provided in the pressure chamber 65, a life span of the liquid ejecting apparatus 11 depends on a limit of a capacity of the pressure chamber 65. In contrast to this, by providing the discharging hole 69, it is possible to extend the life span of the liquid ejecting apparatus 11 without depending on the capacity of the pressure chamber 65.

According to the embodiment, the pressure receiving plate 67a of the movable wall 67 faces the discharging hole 69, and the discharging hole 69 is closed along with a decrease in inner volume of the pressure chamber 65. Accordingly, in a case in which the liquid L in the pressure chamber 65 is suctioned from the discharging hole 69, the pressure receiving plate 67a automatically closes the discharging hole 69, along with a completion of discharging of liquid in the pressure chamber 65. In this manner, it is possible to stop suctioning from the pressure chamber 65 without providing another mechanism for opening or closing a valve, and prevent a load from being applied to the pressure chamber 65. In addition, it is possible to maintain a state in which the receiving member 38 is impregnated with the liquid L, and seals the opening portion 63e, by causing the liquid L to remain in the hole 38c of the receiving member 38 by stopping suctioning from the pressure chamber 65. In this manner, a state in which a meniscus is formed in the hole 38c of the receiving member 38 is maintained, and a state in which the liquid L can be drawn into the pressure chamber 65 thorough the receiving member 38 is maintained.

According to the embodiment, the suctioning portion 54 is used in suctioning of the liquid L filled in the cap 52, suctioning from the nozzle 35 of the cap 52, and suctioning from the liquid receiving unit 61. That is, the suctioning portion 54 can also be used in suctioning of the liquid L which is flushed, suctioning of the nozzle 35 for cleaning, and suctioning of the liquid L which runs off without being accommodated in the medium S when performing borderless printing. Accordingly, it is possible to make a structure simple, without separately providing corresponding suctioning portions, respectively.

The cap 52 in the above described embodiment can move between a capping position of being in close contact with the liquid ejecting head 32 and a retreat position to which the cap moves downward from the capping position. In this manner, the cap 52 also functions as a flushing box which receives flushing from the liquid ejecting head 32, not only capping the liquid ejecting head 32. However, a configuration of preparing a separate flushing box, in addition to the cap 52, may be adopted.

In the above described embodiment, the liquid receiving unit 61 is provided so as to accommodate the liquid L which runs off without being accommodated in the medium S when performing borderless printing. However, the liquid receiving unit 61 according to the embodiment may be adopted in the cap and the flushing box.

The liquid ejecting apparatus 11 according to the embodiment is provided with the exchangeable waste liquid container 70; however, the waste liquid container 70 may not be provided. In this case, it is preferable to set so that the liquid receiving unit 61 can be exchanged when being filled with the liquid L therein, by having a configuration in which the liquid receiving unit 61 is detachable.

The liquid ejecting apparatus 11 according to the embodiment includes the first differential pressure valve 53V and the second differential pressure valve 62V, respectively, in the middle of the paths of the first suctioning tube 53 and the second suctioning tube 62. However, another on-off valve such as an electro-magnetic valve may be adopted, instead of the first differential pressure valve 53V and the second differential pressure valve 62V. In addition, the second differential pressure valve 62V can be omitted.

### Modification Example 1

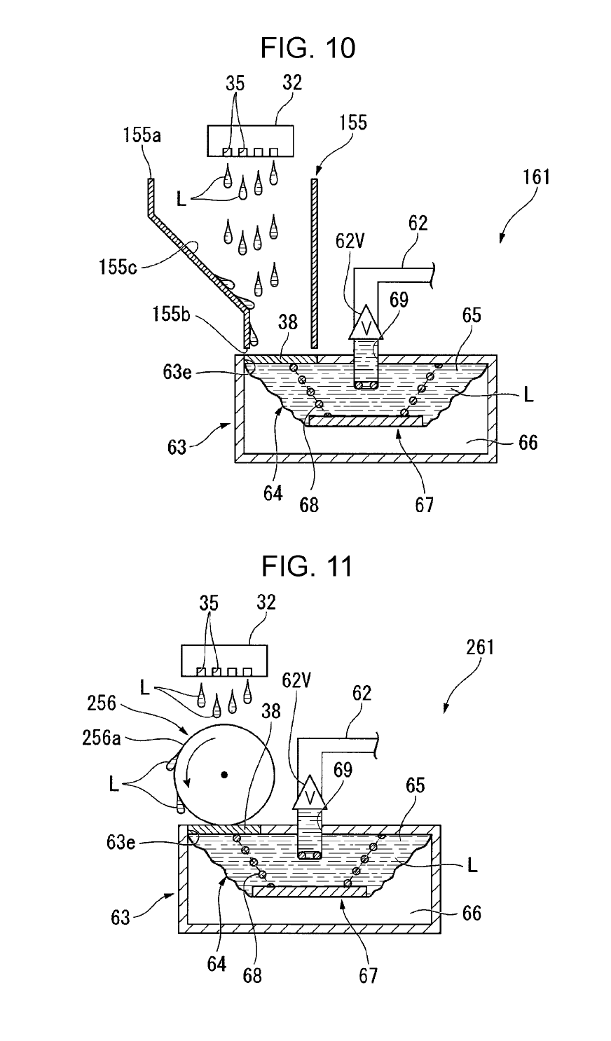

FIG. 10 schematically illustrates a schematic view of a liquid receiving unit 161 in Modification example 1 which can be adopted in the above described embodiment. The same constituent element as that in the above described embodiment is given the same reference numeral, and descriptions thereof will be omitted.

The liquid receiving unit 161 in the modification example will be described as a unit which functions as a flushing box which receives the liquid L ejected from the nozzle 35 of the liquid ejecting head 32. However, similarly to the above described embodiment, the liquid receiving unit 161 may be provided so as to accommodate the liquid L which runs off without being accommodated in the medium S, when performing borderless printing.

The liquid receiving unit 161 is different in a point of further including a liquid collecting unit 155, in addition to the liquid receiving unit 61 in the above described embodiment. The liquid collecting unit 155 collects the liquid L which is ejected in a wide range from the nozzle 35 of the liquid ejecting head 32, and guides the liquid to the receiving member 38.

The liquid collecting unit 155 is formed in a funnel shape with an upper side opening portion 155a and a lower side opening portion 155b. The liquid collecting unit 155 is located between the upper side opening portion 155a and the lower side opening portion 155b, and includes an inclined face 155c which is tapered from the upper side toward the lower side.

The upper side opening portion 155a of the liquid collecting unit 155 is disposed so as to face the nozzle 35 of the liquid ejecting head 32. In addition, the lower side opening portion 155b is disposed so as to face the receiving member 38. The liquid L ejected from the nozzle 35 is collected in the lower side opening portion 155b thorough the inclined face 155c, and is guided to the receiving member 38.

According to the liquid receiving unit 161 in the embodiment, since the liquid L can be locally collected by the liquid collecting unit 155, it is possible to make the receiving member 38 small with respect to a planar dimension of the liquid ejecting head 32, and increase a degree of freedom in disposing of each member in the apparatus.

### Modification Example 2

FIG. 11 schematically illustrates a schematic view of a liquid receiving unit 261 in Modification example 2 which can be adopted in the above described embodiment. The same constituent element as that in the above described embodiment is given the same reference numeral, and descriptions thereof will be omitted.

The liquid receiving unit 261 in the modification example functions as a flushing box which receives the liquid L ejected from the nozzle 35 of the liquid ejecting head 32.

The liquid receiving unit 261 is different in a point of further including a liquid collecting roller 256, in addition to the liquid receiving unit 61 in the above described embodiment. The liquid collecting roller 256 guides the liquid L which is ejected from the nozzle 35 of the liquid ejecting head 32 to the receiving member 38.

The liquid collecting roller 256 is disposed so that an outer peripheral face 256a faces the nozzle 35. A part of the outer peripheral face 256a of the liquid collecting roller 256 is in contact with the receiving member 38. A driving unit (not illustrated) is connected to the liquid collecting roller 256. When the driving roller is driven, the liquid collecting roller 256 rotates around a center axis. The liquid collecting roller 256 guides the liquid L ejected toward the outer peripheral face 256a to the receiving member 38 using an own rotation.

### Modification Example 3

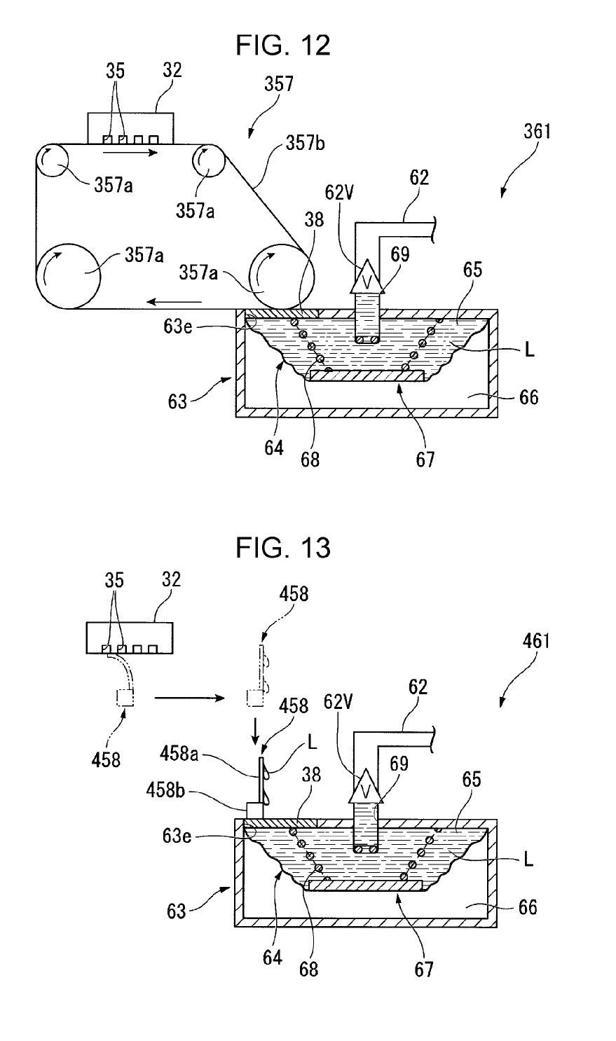

FIG. 12 schematically illustrates a schematic view of a liquid receiving unit 361 in Modification example 3 which can be adopted in the above described embodiment. The same constituent element as that in the above described embodiment is given the same reference numeral, and descriptions thereof will be omitted.

The liquid receiving unit 361 in the modification example is used when cleaning the nozzle 35 of the liquid ejecting head 32.

The liquid receiving unit 361 is different in a point of including a cloth wiper mechanism 357, in addition to the liquid receiving unit 61 in the above described embodiment. The cloth wiper mechanism 357 suppresses an ejection failure such as clogging of the nozzle 35 of the liquid ejecting head 32 by wiping the nozzle.

The cloth wiper mechanism 357 includes a plurality of (for example, four) transport rollers 357a, and a belt-shaped cloth wiper 357b which is wound around the plurality of transport rollers 357a, by applying a tension thereto.

A driving unit (not illustrated) is connected to any one of the plurality of transport rollers 357a, and rotates. In this manner, the cloth wiper 357b is transported between the plurality of transport rollers 357a.

The cloth wiper 357b is wound around the transport roller 357a so as to be in contact with the nozzle 35 and the receiving member 38. The cloth wiper 357b is formed of a cloth material which can absorb liquid attached to the nozzle 35 using a capillary phenomenon in a cavity between meshes. In addition, the cloth wiper 357b delivers liquid absorbed from the nozzle 35 by wiping thereof to the receiving member 38. According to the modification example, it is possible to make the pressure chamber 65 be filled with the liquid attached to the nozzle 35 therein.

### Modification Example 4

FIG. 13 schematically illustrates a schematic view of a liquid receiving unit 461 in Modification example 4 which can be adopted in the above described embodiment. The same constituent element as that in the above described embodiment is given the same reference numeral, and descriptions thereof will be omitted.

The liquid receiving unit 461 in the modification example is used when cleaning the nozzle 35 of the liquid ejecting head 32.

The liquid receiving unit 461 is different in a point of including a rubber wiper mechanism 458, in addition to the liquid receiving unit 61 in the above described embodiment. The rubber wiper mechanism 458 suppresses an ejection failure such as clogging, or the like, of the nozzle 35 of the liquid ejecting head 32, by wiping the nozzle.

The rubber wiper mechanism 458 includes a wiper main body 458a formed of an elastomeric material such as rubber, a support unit 458b which supports the wiper main body 458a, and a driving unit (not illustrated) which is connected to the support unit 458b.

The wiper main body 458a is formed in a plate shape which extends in a depth direction on a paper face in FIG. 13. The support unit 458b supports the wiper main body 458a at a base end side which is located on the lower side of the wiper main body 458a.

In a case of performing cleaning of the nozzle 35, the driving unit causes the wiper main body 458a to be operated thorough the support unit 458b, and wipes off the nozzle 35 using the wiper main body 458a (two-dot dashed line in FIG. 13). In addition, the driving unit stands by, by causing the support unit 458b to be in contact with the receiving member 38. The liquid L wiped off by the wiper main body 458a reaches the support unit 458b thorough the wiper main body 458a, and is received in the receiving member 38 which is in contact with the support unit 458b. According to the modification example, it is possible to cause the liquid L which is attached to the nozzle 35 to be filled in the pressure chamber 65.

Here, a case in which the driving unit causes the support unit 458b to move in the horizontal direction, and performs cleaning of the nozzle 35 is exemplified; however, wiping may be performed by causing the nozzle 35 of the liquid ejecting head 32 to be moved in the scanning direction with respect to the support unit 458b.

Hitherto, the embodiment and the modification examples of the invention are described; however, each configuration, a combination thereof, or the like, in the embodiment and the modification examples are an example, and an addition, omission, a replacement, and a modification other than that of the configuration can be made without departing from the scope of the invention. In addition, the invention is not limited by the embodiment.

For example, the liquid ejecting apparatus in the above described embodiment may be a thermal jet printer, or a line jet printer. In addition, it is not limited to a printer, and may be a device such as a copy machine and a fax machine.

In the liquid ejecting apparatus, a configuration in which liquid other than ink is ejected or discharged may be adopted. The invention can be used in various liquid ejecting apparatuses which include a liquid ejecting head, or the like, which causes liquid droplets of a minute amount to be ejected, for example. The liquid droplets means a state of liquid which is ejected from the above described liquid ejecting apparatus, and includes a granular shape, a tear shape, and a thread shape leaving a trail. Here, liquid may be a material which can be ejected by the liquid ejecting apparatus. For example, the liquid may be a material in a state of a liquid phase, and includes materials which flow such as a liquid body having high or low viscosity, a sol, gel water, and inorganic solvent, organic solvent, a solution, a liquid resin, liquid metal (metallic melt) other than that, and includes materials in which particles of a functional material which is formed of a solid body such as a pigment or metal particles are melted, diffused, or mixed in a solvent, not only liquid as a state of the material.

A representative example of the liquid may be a liquid body, or the like, in which particles of a functional material is dispersed or mixed, in addition to the ink as described in the above embodiments. For example, a configuration in which recording is performed by ejecting a liquid body including a material such as an electrode material, or a color material (pixel material) which is used when manufacturing, for example, a liquid crystal display, an EL (electroluminescence) display, and a surface emission display, or the like, in a form of dispersion, or dissolution. In addition, the ink in the embodiment includes general water-based ink and oil-based ink, and a variety of liquid compositions such as gel ink, hot-melt ink, or the like.

Liquid ejected by the liquid ejecting head 32 is not limited ink, and the medium S is not limited to a sheet, may be a plastic film, a thin plate member, or the like, and may be cloth which is used in a textile printing apparatus, or the like.

The entire disclosure of Japanese Patent Application No. 2016-019526, filed Feb. 4, 2016 is expressly incorporated by reference herein.

What is claimed is:

1. A liquid ejecting apparatus comprising:
a liquid ejecting head which ejects liquid; and
a liquid receiving unit which receives the liquid ejected from the liquid ejecting head,
wherein the liquid receiving unit includes a receiving member which receives the liquid from the liquid ejecting head, a pressure chamber which can communicate with the outside through the receiving member, and a negative pressure generating mechanism which generates a negative pressure in the pressure chamber, and
wherein the receiving member is a porous member which seals the pressure chamber by being impregnated with the liquid.

2. The liquid ejecting apparatus according to claim 1,
wherein the negative pressure generating mechanism includes a movable wall which configures a part of a wall face of the pressure chamber, and is capable of being displaced in a direction of changing an inner volume of the pressure chamber, and an urging member which urges the movable wall in a direction of increasing the inner volume of the pressure chamber.

3. The liquid ejecting apparatus according to claim 1,
wherein the pressure chamber is provided with a discharging hole for discharging the received liquid.

4. The liquid ejecting apparatus according to claim 3,
wherein the movable wall includes a plate body which faces the discharging hole, and
wherein the plate body closes the discharging hole along with a decrease in inner volume of the pressure chamber.

5. The liquid ejecting apparatus according to claim 3, further comprising:
a cap which is capable of being in close contact with the liquid ejecting head; and
a suctioning portion which suctions the liquid from the liquid ejecting head through the cap,
wherein the suctioning portion is capable of suctioning the liquid in the pressure chamber through the discharging hole.

6. The liquid ejecting apparatus according to claim 5, further comprising:
an exchangeable waste liquid container which accommodates the liquid suctioned by the suctioning portion.
